(19) United States
(12) Patent Application Publication
(10) Pub. No.: US 2013/0151421 A1
(43) Pub. Date: Jun. 13, 2013

(54) REAL-TIME PROJECT PROGRESS ENTRY: APPLYING PROJECT TEAM MEMBER-ENTERED PROGRESS IMMEDIATELY TO THE PROJECT PLAN

(71) Applicants: Kristine Lois Van Der Ploeg, Meridian, ID (US); Sivakumar Sundaresan, Union City, CA (US); John Hsieh, San Francisco, CA (US); Kiran Mundy, Lexington, MA (US); Satya Anur, Redwood Shores, CA (US); Priyanka Shetye, Foster City, CA (US); Margaret Wasowicz, Harrisburg, NC (US); William Caine, Fremont, CA (US); Bormi Shin, Redwood City, CA (US)

(72) Inventors: Kristine Lois Van Der Ploeg, Meridian, ID (US); Sivakumar Sundaresan, Union City, CA (US); John Hsieh, San Francisco, CA (US); Kiran Mundy, Lexington, MA (US); Satya Anur, Redwood Shores, CA (US); Priyanka Shetye, Foster City, CA (US); Margaret Wasowicz, Harrisburg, NC (US); William Caine, Fremont, CA (US); Bormi Shin, Redwood City, CA (US)

(73) Assignee: Oracle International Corporation, Redwood Shores, CA (US)

(21) Appl. No.: 13/314,910

(22) Filed: Dec. 8, 2011

(51) Int. Cl. G06Q 10/06

(52) U.S. Cl. 705/301

(57) ABSTRACT

Embodiments of this invention relate generally to updating a project plan in accordance with an input. A user may have a limited set of privileges to update the project plan compared to a manager. The manager may provide a threshold value relating to a type of change that may be made to a master version project plan. Next, the user may access the master project plan, and provide an input relating to a proposed change. From the change, a change value may be derived, and the change value may be compared to the threshold value to determine whether the change value violates the threshold value. If the change value violates the threshold value, a change exception may be generated, and the manager may be notified that the proposed change requires review. If the change value does not violate the threshold value, then the master project plan may be immediately updated.

### CROSS-REFERENCES TO RELATED APPLICATIONS

This application is related to co-pending U.S. patent application Ser. No. 12/508,958 filed on Jul. 24, 2009 entitled “ENABLING COLLABORATION OF A PROJECT PLAN” which is incorporated herein by reference.

### TECHNICAL FIELD

The present disclosure generally relates to a system for managing changes to a project plan for a project team. More particularly, the embodiments described herein relate to systems and methods for enabling team members to keep a project plan up-to-date for the project team.

### BACKGROUND OF THE INVENTION

In a business environment, a team of people may be grouped together in order to complete a specific project. A project plan may be utilized to define how a project is to be completed, how certain goals are to be accomplished, and how various tasks may be organized. The project plan may list different tasks and/or milestones, and the project plan may assign those tasks to different people on the team. Often, a project plan may include tasks that are related hierarchically, where some tasks must be completed before other tasks can be started. A project plan may also include dates or times when certain tasks are scheduled to be completed in order for the project to be completed on schedule and within an estimated budget.

As a project plan is executed, various problems may arise that may affect the schedule, cost, and/or organization of the project. In these cases, it may be necessary to change the project plan in order to accurately estimate schedule and/or cost. Project plans are typically controlled by a project manager who has privileges that allow him/her to alter the project plan. The rest of the project team may view a copy of the project plan to track their schedules and progress, and recommend changes to the project plan when problems arise that affect their schedule and progress. The project manager may accept or reject the changes recommended by members of the project team. Thus, the project manager acts as a gatekeeper for every change proposed by team members in order to protect the integrity of the project plan, even when those changes are relatively inconsequential. Hence, improvements in the art are needed.

### BRIEF SUMMARY OF THE INVENTION

Embodiments of this invention relate generally to updating a project plan in accordance with input received from a user. The user may have a limited set of privileges to update the project plan, whereas a manager may have more privileges to update the project plan than the user. The manager may provide a threshold value relating to a type of change that may be made to a master version project plan. Next, the user may access the master project plan, and provide an input relating to a proposed change to the master project plan. From the proposed change, a change value may be derived, and the change value may be compared to the threshold value to determine whether the change value violates the threshold value. If the change value violates the threshold value, a change exception may be generated, and the manager may be notified that the proposed change requires review. If the change value does not violate the threshold value, then the master project plan may be immediately updated by the proposed change.

In one embodiment, a method of updating a project plan in accordance with input received from a user account is presented. The method includes storing a master version of the project plan, wherein the master version of the project plan is stored as live data in a database. The method also includes receiving, from an administrative account, a threshold value, wherein the threshold value divides a range of possible values into first and second non-overlapping sets of values, and wherein the first set of values represents types of changes that may be made to the master version of the project plan in real-time without an approval from the administrative account. The method further includes after receiving the threshold value from the administrative account, receiving, from the user account, a change to the project plan; wherein the user account has limited privileges to update the master version of the project plan in real-time; and the administrative account has more privileges to update the master version of the project plan in real-time than the user account. The method additionally includes deriving a change value corresponding to the change in the project plan, wherein the change value is of the same type as the threshold value. The method also includes determining that the change value does not violate the threshold value if the change value is included in the first set of values; and in response to determining that the change value does not violate the threshold value, updating the master version of the project plan in real-time to reflect the change in the project plan.

In another embodiment, a system for updating a project plan in accordance with input received from a user account is presented. The system may include a storage device having sets of instructions stored thereon, and a processor coupled with the storage device. The sets of instructions when executed by the processor, cause the processor to store a master version of the project plan as live data in a database and receive, from an administrative account, a threshold value, where the threshold value divides a range of possible values into first and second non-overlapping sets of values, and where the first set of values represents types of changes that may be made to the master version of the project plan in real-time without an approval from the administrative account. The sets of instructions may also cause the processor to receive, from the user account, a change to the project plan, where the user account has limited privileges to update the master version of the project plan in real-time, and where the administrative account has more privileges to update the master version of the project plan in real-time than the user account. The sets of instructions may further cause the processor to derive a change value corresponding to the change in the project plan, where the change value is of the same type as the threshold value, and determine that the change value does not violate the threshold value if the change value is included in the first set of values. The sets of instructions may further cause the processor to update the master version of the project plan in real-time to reflect the change in the project plan in response to determining that the change value does not violate the threshold value.

In another embodiment, a computer-readable medium having sets of instructions stored thereon. When the sets of instructions are executed by a computer, they may cause the computer to store a master version of the project plan as live data in a database, and receive, from an administrative account, a threshold value, where the threshold value divides a range of possible values into first and second non-overlapping sets of values, and where the first set of values represents types of changes that may be made to the master version of the project plan in real-time without an approval from the administrative account. The sets of instructions may further cause the processor to receive, from the user account, a change to the project plan, after receiving the threshold value from the administrative account, where the user account has limited privileges to update the master version of the project plan in real-time, and the administrative account has more privileges to update the master version of the project plan in real-time than the user account. The sets of instructions may also cause the processor to derive a change value corresponding to the change in the project plan, where the change value is of the same type as the threshold value, and determine that the change value does not violate the threshold value if the change value is included in the first set of values. The sets of instructions may additionally cause the processor to update the master version of the project plan in real-time to reflect the change in the project plan, in response to determining that the change value does not violate the threshold value. Moreover, the sets of instructions may cause the processor to generate a change exception, and provide the change exception for review by the administrative account in response to determining that the change value does not violate the threshold value.

### BRIEF DESCRIPTION OF THE DRAWINGS

A further understanding of the nature and advantages of the present invention may be realized by reference to the remaining portions of the specification and the drawings. Like reference numerals are used throughout the several drawings to refer to similar components. In some instances, a sub-label is associated with a reference numeral to denote one of multiple similar components of different embodiment of the same component. When reference is made to a reference numeral without specification to an existing sub-label, it is intended to refer to all such multiple similar components or embodiments.

FIG. 1 illustrates a block diagram of an embodiment of a project plan collaboration module.

FIG. 2 illustrates a flow chart for changing the master project plan, in accordance with an embodiment of the present invention.

FIG. 3 illustrates a flow chart for determining whether a change is allowed, in accordance with an embodiment of the present invention.

FIG. 4A illustrates a flow chart for determining whether a particular type of change is allowed, in accordance with an embodiment of the present invention.

FIG. 4B illustrates a flow chart for determining whether a particular type of change is allowed, in accordance with an embodiment of the present invention.

FIG. 5 illustrates a flow chart for an embodiment of a review process for changes that violate a threshold value.

FIG. 6 illustrates a display interface for analyzing proposed changes to the project plan according to one embodiment.

FIG. 7 illustrates an environment with which embodiments may be implemented with a computer system.

FIG. 8 illustrates an embodiment of a special-purpose computer system.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with other embodiments as well. By the same token, however, no single feature or features of any described embodiment should be considered essential to the invention, as other embodiments of the invention may omit such features. It is understood that various changes may be made in the function and arrangement of elements without departing from the spirit and scope of the invention as set forth in the claims.

Project plans are often used in business to help define tasks that are assigned to the members of a project team. Project plans may define relationships between tasks in a hierarchy and may include dependency information between tasks. For example, aspects of one task may depend upon the completion of another task, or the tasks may need to be completed in parallel with each other. Project plans may include time and date information for determining when each task should be completed, as well as cost estimates, effort estimates, and/or team assignments. In short, a project plan may include much of the information necessary for the efficient management of the project.

When a project plan is established, a representation of the project plan may be distributed to each member of the team to provide the information that the members need to understand how the project can be completed and who is responsible for each task. Sometimes, only the relevant portions of the plan are provided to the respective members so the each member can see the particular portions for which that member is responsible. During the creation of the project plan, the team members may give feedback and inform the project manager of any known conflicts or other problems that may impede the flow of tasks or the completion of the project. In this respect, the project plan may go through one or more revisions that include input from team members after a final plan is established.

Generally, the project plan is a conceptualization of how the project is to proceed. In this disclosure, the term project plan will usually refer to a version of the conceptualization that is stored in a computer system. Specialized software systems are commercially available for creating, editing, analyzing, and sharing computer representations of project plans. One such software product is the Fusion Portfolio Management suite from Oracle®. Another software product could be Microsoft® Project. Software suites such as these display a graphical representation of a project plan in various formats that make relevant details apparent to the user, such as time, effort, and dependency between tasks. One such graphical representation is known as a Gantt chart, which displays multiple tasks related to a project on a timeline where task dependencies are visually apparent.

In most computerized project management systems, team members are allowed to access, view, and analyze graphical representations of the project plan in order to carry out the tasks that are assigned to them. As stated above, each team member may only have access to that portion of the project plan that applies to the tasks to which he/she is assigned. However, a project manager will generally have access to the entire project plan.

When a project plan requires a change, many systems assign different privileges to the various team members. These privileges determine who is allowed to change the project plan. Generally, only the project manager has sufficient privileges to change the project plan in all aspects. Team members generally do not have privileges that allow them to make changes on their own. Therefore when a team member desires to make a change to the project plan, the change is submitted to the project manager for approval. Submitted changes from one team member are not available to the other team members until the changes are approved by the manager.

This current system for submitting changes often results in delays that can negatively affect the project. Team members are often more qualified than the project manager to determine when minor changes need to be made to the project plan. For example, an engineer will often know before the project manager if a technical problem may cause a short delay in the project plan, and a procurement specialist will often know before the project manager when additional costs may affect the estimated cost of the project. Despite the expertise of the team members, all of these changes must still be passed to the project manager for approval before the project can be updated and displayed for the rest of the team. In fact, for some of the changes, especially those based on technical or financial details, those submitting the change are more qualified to determine whether the change is necessary, and as a consequence, the project manager often approves these changes with little consideration, relying instead on the expertise of those who submitted the changes.

While this system does create a central gateway for all changes to the project plan, it also has several drawbacks. Project management systems typically allow only project managers to enter progress after collecting the progress off-line, such as via e-mail or verbally from the project team members. By definition, the progress data are stale, or out-of-date, by the time the project manager receives them, and hence they are even more out-of-date by the time they are entered into the project plan. Occasionally, team members may be allowed to enter changes directly into the software system; however, these changes are not available until they are approved by the project manager. Again, this situation leads to stale data begin displayed to other members of the project team until the changes are approved by the project manager. This problem is particularly pronounced in large and complicated projects, which may result in hundreds of changes over the course of the project that the project manager would need to sift through and approve. Furthermore, when data displayed to the project team members are stale, multiple team members may propose similar or conflicting changes to the project plan that are difficult to resolve. These conflicts may multiply if the changes involve dependent tasks. When this happens, the project manager may spend a good deal of time doing mundane data collection, entry, and approval instead of more productive management activities.

Since keeping project progress on track is one of the most crucial aspects to managing a project successfully, project managers are frequently frustrated by not knowing the actual, current status of the project's tasks. Project mangers also need to be able to spot possible delays or other such issues as quickly as possible, but are often stymied because of the age of the project progress data. Furthermore, project managers need to be notified of possible delays or obstacles to the project's progress from their team members as soon as possible. Even if project management software systems provide the means for such communications, the information is invariably as stale as the rest of the project progress data by the time the project manager sees it.

Embodiments of the current invention provide solutions for these and other problems associated with keeping data current in a project plan. In some embodiments, instead of providing copies of the project plan to team members when they want to view, analyze, and/or alter the project plan, the team members are provided with access to a master version of the project plan, referred to herein as the master project plan. By providing access to the master project plan, each team member is operating on and viewing the same data set. All updates to the master project plan are immediately available to all team members who are given access.

Additionally, the team members are allowed to make changes directly to the master project plan without requiring manager approval in certain instances. This may eliminate much of the overhead in managing a project and allow the team members who are best acquainted with the schedule, cost, manpower, and/or effort requirements of a task to make necessary changes. This may also eliminate the problem of stale data. When a project manager views the master project plan, but for a few exceptions requiring approval, the data in the project plan will be up-to-date. The embodiments of this solution use a threshold mechanism that allows a project manager to adjust the level of control he/she exercises over project plan changes. In other words, the project manager may establish a threshold value for each type of change, and then set the value at the point where approval may be necessary. The project manager may consider changes that fall below the threshold as ones not requiring prior approval, while changes that fall above the threshold may be considered ones that still require prior approval. These and other solutions may be implemented in a project plan collaboration module in a computer system.

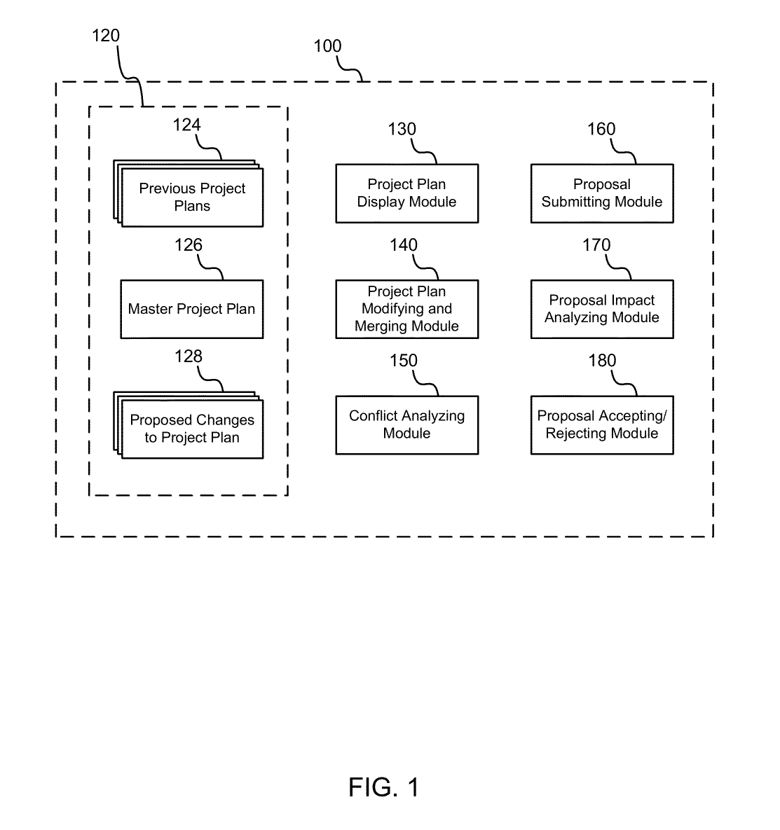

FIG. 1 illustrates a block diagram showing an embodiment of a project plan collaboration module 100. In this embodiment, the project plan collaboration module 100 includes a project plan database 120 configured to store, among other things, one or more previous project plans 124, a master project plan 126, and proposed changes to the project plan 128. Previous project plans 124 may include plans that were eventually replaced by the current master project plan 126. If necessary, these may be retrieved when it is determined, for example, that the master project plan 126 includes conflicts or is infeasible for some reason or if a change needs to be retroactively rejected. The master project plan 126 represents the project plan that is considered to be the current plan in place for the project team, at least until it is replaced by a proposed change. Proposed changes to the project plan 128 may include one or more proposed modifications to the master project plan 126, or other complete project plans under consideration to replace the master project plan 126.

In some embodiments, the previous project plans 124 and the proposed changes to the project plan 128 may be complete copies of the project plan wherein changes have been made such that the change defines how they are different from the master project plan 126. Alternatively, instead of using complete copies of the project plan, the previous project plans 124 and the proposed changes to the project plan 128 may be represented by details that have been or will be changed in the master project plan 126. For example, a proposed change may include a changed due date, and the proposed changes to the project plan 128 may store this change as a task identifier and the changed date instead of storing a complete copy of the master project plan 126 that incorporates the changed date.

If one of the proposed changes to the project plan 128 is accepted as a replacement for master project plan 126, then this new plan may be stored and referred to at that point as the master project plan 126, and the accepted change may be removed from the proposed changes to the project plan 128. The now-outdated master project plan 126 may then be stored in the previous project plans 124.

In addition to project plan database 120, project plan collaboration module 100 may also include a project plan display module 130, a project plan modifying and merging module 140, a conflict analyzing module 150, a proposal submitting module 160, a proposal impact analyzing module 170, and a proposal accepting/rejecting module 180. Project plan display module 130 may be configured to display the contents or a portion of the contents of the project plan for a team member or a project manager wishing to view the project plan. Usually, the project plan display module 130 may be configured to display the master version of the project plan 126 for the requesting team member. Additionally, the project plan display module 130 may cause one of previous project plans 124 or one of the proposed changes to the project plan 128 to be displayed upon request. The project plan display module 130 may cause a project plan to be displayed on a display device that is coupled directly to the project collaboration module 100, or the project plan display module 130 may cause a project plan to be displayed over a network, at a remote workstation, on a mobile computing device, and/or on any other system with a means for displaying information to a user.

The project plan modifying and merging module 140 may be configured to enable the project manager to modify the master project plan 126 and/or merge at least a portion of master project plan 126 with at least a portion of another plan. In some cases, these modifying and merging procedures may be accomplished by commands from the project manager without analysis of the consequences. If the project manager wishes to undo the changes, the project manager may retrieve one of the previous project plans 124, specifically the project plan that was replaced or which was formerly the master project plan 126 before modifications and/or merges were executed.

The conflict analyzing module 150 is configured to determine whether or not the tasks and/or timeframes of master project plan 126, or one of the proposed changed to the project plan 128, include any conflicts. For example, there may be conflicts with respect to the assignment of tasks to incorrect or unauthorized team members. There may be timing conflicts that may result from task dependencies, where one task must be completed before another task can begin. There may also be too many tasks assigned to a single team member such that his/her required effort would exceed some work limit. Also, if individuals are members of multiple project teams, the conflict analyzing module 150 may analyze multiple project plans between different teams to identify conflicts.

The proposal submitting module 160 is configured to enable a team member to interact with the master project plan 126, or at least the portions of the master project plan 126 that are associated with the duties of that particular team member. The proposal submitting module 160 also enables the team member to make modifications to the master project plan 126 and then submit these modifications, as one of the proposed changes to the project plan 128, to the project manager. Previous to this invention, the master project plan 126 could not be changed by a team member unless he/she had privileges similar to the project manager. Every change required the project manager to review and accept proposed changes. If the project manager did not wish to implement the proposed plan, the proposal would be rejected, and the master project plan 126 would remain unchanged. However, as will be discussed in further detail below, depending on the type of change and/or the status of the team member, the proposal submitting module 160 may be configured to accept a change from a team member and update the master project plan 126 without requiring manager approval. On the other hand, when a team member submits a proposal using proposal submitting module 160 that does require manager approval, the proposal submitting module 160 may enable the project manager to analyze the proposal and then accept or reject the proposal.

The proposal impact analyzing module 170 may be configured to present a proposal requiring approval to the project manager. The proposal impact analyzing module 170 enables the project manager to initiate a process to cause proposal impact analyzing module 170 to automatically run the changes through the master project plan 126 and determine any consequential changes upstream or downstream from the proposed changes. For example, if one or more tasks are changed, the impact of those changes may be carried through to other parts of the project plan. The proposal impact analyzing module 170 may analyze the impact, consequences, and/or extent of the changes on other tasks, timeframes, operators, etc., which may depend on the proposed change. Once the proposal impact analyzing module 170 has completed an analysis of the impact of the proposal, this analysis can be reported and/or visually displayed to the project manager, who can then decide if the resulting project plan is preferred to the master project plan 126.

If the proposed project plan is preferred to the master project plan 126, the proposal accepting/rejecting module 180 is configured to enable the project manager to accept the proposal. In this case, the proposal, along with the calculated impact of the proposal on the rest of the plan, is saved as the master project plan 126. Then, when the master project plan 126 is retrieved by a team member or the project manager, this new project plan is presented as the master project plan 126. On the other hand, if the project manager decides that the impact of the analyzed proposal is not preferred to the master project plan 126, then the proposal accepting/rejecting module 180 enables the project manager to reject the plan. When the proposal is rejected, a notice may be sent to the proposing team member to indicate the proposal was not accepted. Also, according to some embodiments, any proposed changes to the project plan 128 related to the rejected proposal may be deleted. If the master project plan 126 was erroneously replaced by the proposal, the replaced project plan may be retrieved from previous project plans 124 and be returned to its rightful status as the master project plan.

Turning now to a more detailed description of the process for changing the master project plan 126, there are a number of different embodiments, each one using a different method for sharing the master project plan 126 with team members and a different method for changing data with in the master project plan 126. In a first embodiment (not shown), when a team member desires to view the project plan, the project plan display module 130 may cause to be displayed a representation of the master project plan 126 on a user display device. The team member may be provided with a copy of the master project plan 126 that is transmitted locally to the team member. In this case, any changes made and submitted by the team member are only applied to the copy of the master project plan. The copy then awaits approval from the project manager. The practical consequence of this arrangement is that if a different team member requests to view the master project plan 126 from the project plan display module 130 before the changes of the team member are approved, the changes will not be visible to the different team member.

In another embodiment (not shown), a single shared copy of the master project plan 126 may be made available to every team member requesting a view from the project plan display module 130. The shared copy permits the team member to make changes to the master project plan 126 and is the same for all other team members (i.e., has the same content). In some cases, the team member may only change tasks that are assigned to him/her. For example, assume that the team member makes changes to the start date, end date and planned hours for his/her tasks, and a different team member makes changes to the start date, end date and planned hours for tasks assigned to him/her. If these changes require the approval of a project manager, they will appear on the shared copy but not on the master project plan 126. In other words, changes made in the shared copy, while unapproved, are visible only to the team member 220 who made the change and the project manager, and do not affect the remainder of the plan (i.e., no rollup or downstream impact). The view of the single shared copy provided by the project plan display module 130 may vary depending on the privileges of the team member.

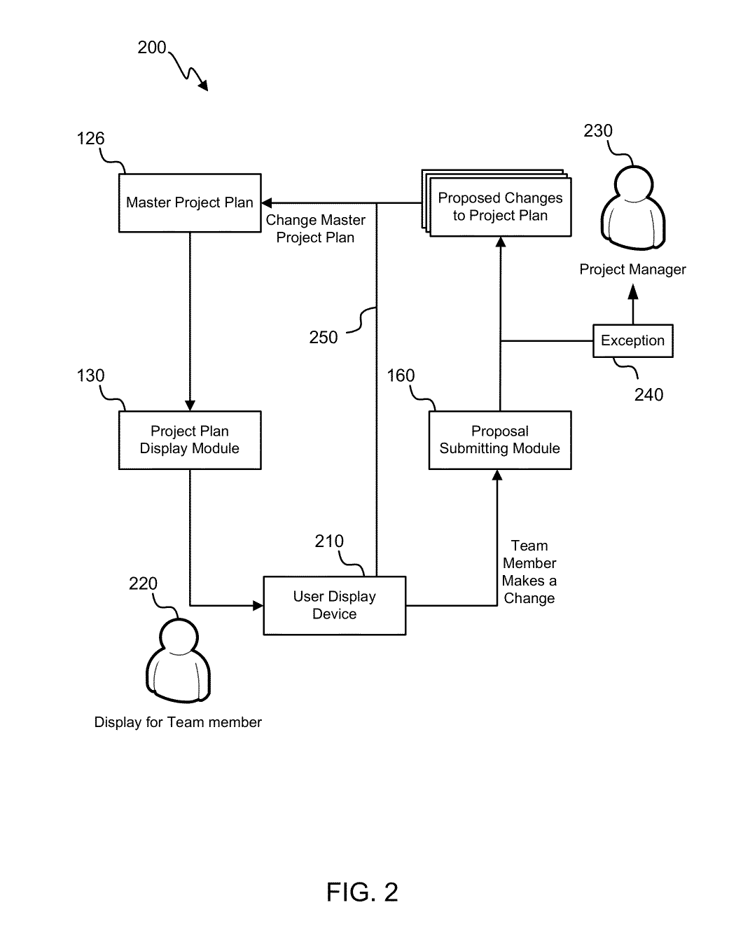

FIG. 2 illustrates a flow chart 200 for changing the master project plan 126, in accordance with a preferred embodiment of the present invention. In this embodiment, a team member 220 may be given direct access to the master project plan 126. When the team member 220 desires to view the project plan, the project plan display module 130 may cause to be displayed a representation of the master project plan 126 on a user display device 210. Thus, the user display device 210 may display the actual data of the master project plan 126 queried from the project plan database 120. This is significant because it reduces the number of copies that exist at any one time and ensures that the most up-to-date information about the project plan is available in the master project plan 126. This eliminates the need for the shard copy described above in order for other team members to view current changes submitted by the team member 220. Most significantly, direct access to the master project plan 126 allows the team member 220 to make changes directly to the master project plan 126, so long as the changes do not require the approval of a project manager 230.

If the team member 220 makes a change to the master project plan 126, the project plan collaboration module 100 may take at least one of two actions. First, the project plan collaboration module 100 may allow the changes of the team member 220 to immediately affect the master project plan 126. In other words, when the team member 220 makes a change to the project plan that he/she sees on the user display device 210, the change is made to the actual data in the master project plan 126 that is stored in the project plan database 120. This scenario is represented by pathway 250 in FIG. 2. For this scenario to occur, the project plan collaboration module 100 must determine whether the team member 220 is allowed is make this type of change to the master project plan 126 without approval from the project manager 230. This determination may be made by software or hardware co-located with the user display device 210, or by the proposal submitting module 160, or by other systems that may be associated with the project plan collaboration module 100. Embodiments that illustrate how it is determined whether a change by the team member 220 is allowed without the approval of the project manager 230 are described in greater detail below.

In the case where the team member 220 is not allowed to make the particular change directly to the master project plan 126 without the approval of the project manager 230, a change exception 240 is generated. The change exception 240 may take many forms, including an alert sent to the project manager 230 requesting that the proposed change be reviewed for approval. The alert may also take the form of an e-mail, a voicemail, a visual alert on the screen of a computing device used by the project manager 230, and/or a notification or option in the project plan collaboration module 100 allowing the project manager 230 to review the change. Additionally or alternatively, the change made by the team member 220 may be formatted as a proposed change to the project plan and be routed to the proposed changes to the project plan 128 in the project plan database 120. The project manager 230 may then review the change and approve or reject the inclusion of the change in the master project plan 126.

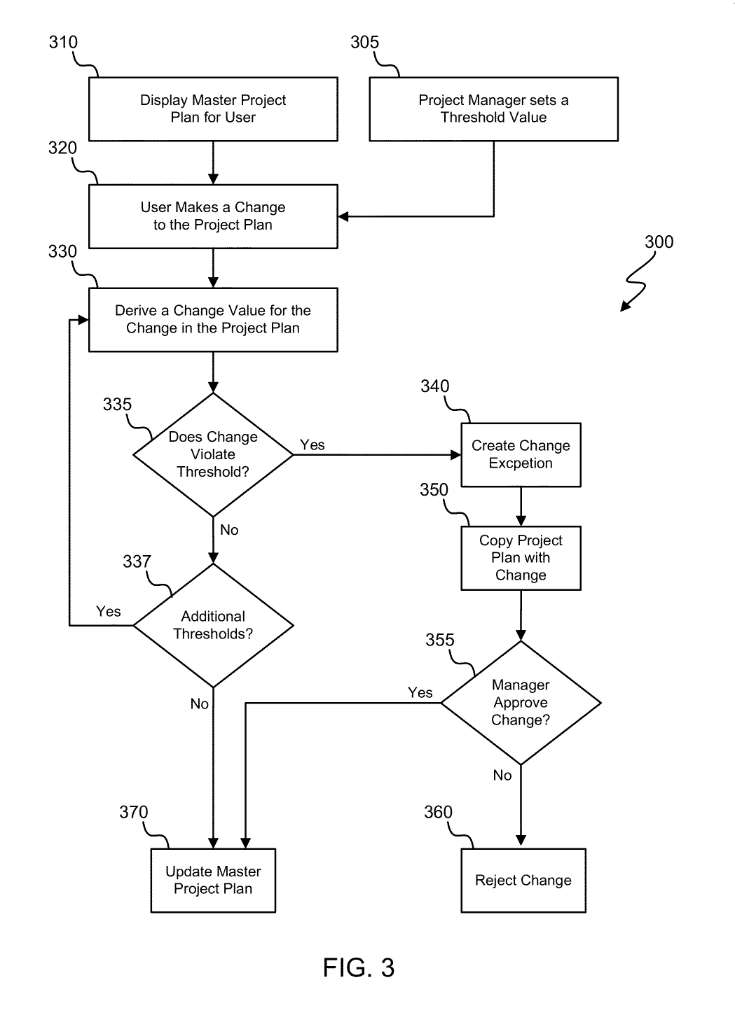

Turning now to a more detailed discussion of determining whether the team member 220 is allowed to make a change directly to the master project plan 126 without approval from the project manager 230, FIG. 3 illustrates a flow chart 300 for determining whether a change is allowed, in accordance with an embodiment of the present invention. At process block 305, the project manager 230 sets a threshold value relating to at least one type of change that may be made by the team member 220. Broadly, the threshold value may be thought of as a limit on the size or consequences of a type of change. For example, if the project manager 230 is concerned with the amount of effort expended by the team member 220 to accomplish a task in the master project plan 126, the project manager may set a threshold value that limits the total amount of effort the team member 220 may exert on a particular task. Thus, setting a threshold value usually involves identifying a metric or measurable range of a quantity related to a task (effort, cost, schedule, number of employees, etc.) and assigning a limitation within that range. The threshold value represents the amount that the team member 220 is allowed to change the metric without requiring manager approval. The threshold value may also divide the range of possible values into two non-overlapping sets of values wherein one of the sets of values indicates a condition where a change may be allowed, and the other set of values indicates a condition where a change may not be allowed.

In some embodiments, the metric or measurable range of a quantity related to a task may be a personal attribute of the team member 220 or others assigned to the task. For example, the metric or measurable range may describe the range of employees that the team member 220 may assign to or remove from the task. The metric or measurable range of a quantity related to a task may also involve a range of task types that may be created or changed by the team member 220. For example, the project manager may identify a set, or range, of task types, such as financial tasks, coding tasks, code testing tasks, and/or architecture tasks, etc. These task types may be segregated into groups, or placed in an order of importance, either by the project manager 230 or by the project plan collaboration module 100. The project manager 230 may set the threshold value to be membership in a group of tasks, or to be a certain duration a task may take to complete.

It will be understood that this invention conceives of may different types of threshold values. In some embodiments, the metric or measurable range of a quantity related to a task is represented by a numeric scale, such as dollars spent on a task, or a completion date. In these, setting the threshold value may include simply selecting a numeric value from a range of possible values. However, as should be clear from the examples above, the metric or measurable range of a quantity related to a task need not be limited to a numeric scale. The range of values may be discreet, such as categories of employees, and/or may involve complex hierarchical relationships, such as company's organizational chart. Furthermore, the threshold value need not relate to each of the possible values in a “greater-than, less-than” relationship. Instead the threshold value may indicate a division between possible values of the range. For example, the threshold value may represent authorization for employees from a certain department to change the master project plan 126. Additionally, the threshold value may combine types of relationships that both exclude and include “greater-than, less-than” relationships. For example, the threshold value may represent authorization for employees from a certain department to change the master project plan 126, as well as any departments that are beneath the certain department on an organizational chart. A threshold value may also represent dependencies between different tasks or even different projects. In some embodiments, a threshold value may be chosen as a number of dependent tasks that will be affected, or as a quality representing other ways that dependent tasks may be affected. For example, a threshold value may be a time delay the change causes in a dependent task, such as a production date. Or, a threshold value may be a net cost change for all dependent tasks. Various combinations of the types of thresholds described above may also be used.

Threshold values may be set in any area that affects the master project plan 126 or any of the tasks therein. Possible areas in which it may be useful to set a threshold may include: the number of hours the team member 220 or the project team as a whole are allowed to work on a project or on certain tasks; the actual start date for any effort expended on a task; changes to any estimated deadline times and/or conditions; number of hours estimated for a certain task; number of team members allowed to charge time to a task; actual completion dates for a task; and cost, equipment, purchases, procurements, collaborations, or dependencies of or for the tasks within a the master project plan 126. This list is only illustrative and not meant to be limiting. In light of this disclosure, it will be understood that other types of thresholds will fall within various embodiments of this invention.

Some embodiments may combine different threshold values to create a single threshold value. Any types of threshold values may be combined together using logical operators. For example, a threshold value may be selected which limits changes to be made to the master project plan 126 by any team member at or above a certain employee level. It may also be desirable to further limit the type of changes allowed by these team members to changes that do not affect a final delivery date of a product. Here, the threshold value may comprise two separate ranges, i.e., employee level, and schedule impact. A threshold value may be set, such as one representing “employee level of senior staff, and two weeks of delay.” Alternatively, it may be desirable to allow a team member 220 to make any change, so long as it does not affect the cost of the task. In this case, the threshold values could represent “team member unless cost is greater than zero,” or “team member and cost equals zero.” Any combination of threshold values may be used, and they may be combined using logical operations, Boolean operators, or business rules set by an organization.

Additionally, some embodiments may require that the threshold be a “nonzero” value. In other words, it may be required that the threshold allow some changes while also requiring some changes to generate a change exception and require approval. For example, if the project manager 230 were to set a threshold for an employee level, it would have to be set to some employee level such that not every employee level would be able to make changes without approval. On the other hand, another embodiment does away with this restriction and allows the project manager 230 to either allow any change in a certain category, or to not allow any changes in a certain category.

Returning to FIG. 3, process block 310 displays the master project plan 126 to the team member 220. In one embodiment, the current state of the master project plan 126 is displayed, such that all changes previously made by other team members are visible to the team member 220, and such that all changes made by the team member 220 that do not violate a threshold value may be immediately visible to other team members. For example, if the team member 220 is viewing the master project plan 126 at the same time as another team member, then any change made by the team member 126 may be immediately available for the other team member to view. The change may be displayed to the other team member automatically or during a periodic data refresh, or project collaboration module 100 may send a notification to the other team member that the current view is out of date and should be refreshed.

The team member 220 may analyze the master project plan 126 without making any changes. This may not require any action by a project manager 230, such as setting a threshold value. (This is one reason why process block 305 is parallel to process block 310 in FIG. 3.) When the team member 220 makes a change at process block 320, the project collaboration module 100 may determine whether or not to apply the change to the master project plan 126 by determining whether any threshold values have been violated as described below.

At process block 330, a change by the team member 220 is analyzed to determine a change value. This process may be very similar to the process described above for identifying and setting a threshold value. In some embodiments, a listing of threshold values may be analyzed, and those that relate to the change in the project plan may be identified. Each identified threshold value may then be compared to the change to identify a range of possible values, and from that range, a change value that may be compared to the threshold value may be derived. For example, if the team member 220 changes the completion date for a task, threshold values specifying a maximum delay to the product ship date and the employee level may be identified from a list of defined threshold values. Then, change values corresponding to the threshold values may be derived from the change in the project plan. In this case, if changing the date in the task affects the final shipping date of the product, then that delay may be extracted as a change value. Additionally, the employee level of the team member 220 may be “senior technical staff,” which may also be derived as a change value. Other embodiments may alter the process for deriving a change value to end up with a similar result.

Some embodiments may also access and use a history of change values in addition to current change data in order to derive a change value, particularly if a threshold value sets a cumulative maximum value. The corresponding change value then would not only include the current additional value, but any other past additions to that value since the time the threshold value was set. For example, the threshold value may set a maximum cumulative delay for a particular task deadline. When a change to the estimated completion date of the task is submitted by the team member 220, deriving the change value may include not only the delay from the current change, but also any prior delays that were added to the same task. This may prevent small incremental changes from circumventing a threshold value if only the immediate change to the master project plan 126 were to be considered.

Once one or more change values are derived from the change to the project plan, decision block 335 compares the change value to the threshold value to determine whether the threshold value has been violated. In this context, if a change value “violates” a threshold value, the change value is one that falls outside of an acceptable range of values, wherein the threshold value serves a boundary. In some case, this may be a “greater-than, less-than” comparison between two numeric values, such as when the threshold is a cost limit and the change value is a new cost estimate. In other cases, this may be a simple division between two sets of possible values, such as when the threshold value is membership in a certain set of employee departments and the change value is the employee department of the team member 220.

Determining a violation of the threshold value may go beyond a “greater-than, less-than” comparison to involve many types of comparison operations. Set theory operators, such as “member of” or “not a member of” maybe used when the possible change values are discreet and denote qualities of a change rather than quantities of a change. Additionally, the deriving change values and determining whether they violate a threshold value may involve both absolute and relative comparisons. For example, a threshold value may set an absolute limit on the total cost of a task. Alternatively, a threshold value may set a limit on the allowed change to the total cost of a task. In each case, the change value that is derived from the change may be derived to match the type of the threshold value. Thus, in the first case, the change value would correspond to the new total task cost, and in the second case, the change value would correspond to the change in total task cost. Additionally, threshold values could be set for each of these two cases, and both could be checked together for a violation.

Each threshold value and change value pairing may be checked for a violation before the change is allowed and the master project plan 126 is updated. Process block 337 determines whether more change values need to be checked against a threshold value for a violation. As the process is arranged in FIG. 3, as soon as a single threshold value is violated, the change requires manager approval and the remaining change values and thresholds might not be evaluated. However, in other embodiments, every change/threshold value pair is checked before a change is allowed or not. This may give a more complete report to the project manager 230 as to why the change requires approval.

Some embodiments may also allow for comparisons between multiple threshold values. For example, a voting scheme could be instituted wherein if certain number threshold values are not violated in comparison to the number of threshold values that are violated, then a change may be approved. Alternatively, different weights could be associated with different threshold values, such that when multiple thresholds are evaluated, the unviolated thresholds may outweigh the violated thresholds. In other embodiments, the degree to which thresholds may be violated may also be considered. For example, if a cost threshold is violated by a small margin, but a delay threshold is a large margin away from being violated, the combination of the two change value and the two threshold values may result in a net change value that does not violate the net threshold value. Of course, various translation methods could be used to make compatible the various threshold values and change values that use different ranges of values and comparison techniques.

If overall the threshold values of are not violated by the change to the project plan, then the process block 370 may update the master project plan 126 to reflect the change. The change may then immediately be available for viewing by other team members, and the previous master version could be stored in the previous project plans 124. On the other hand, if a violation of the overall threshold value is determined (which may include combinations of individual thresholds) then the proposal submitting module 160 may generate a change exception 240 indicating that the change requires manager approval to take affect. The project collaboration module may also create a copy of the master project plan 126 that incorporates the change and store the copy in the proposed changes to the project plan 128 at process block 350. At some point, the project manager 230 may review the change in decision block 355, and either reject the change at process block 360, or update the master project plan 126 to incorporate some or all of the change at process block 370.

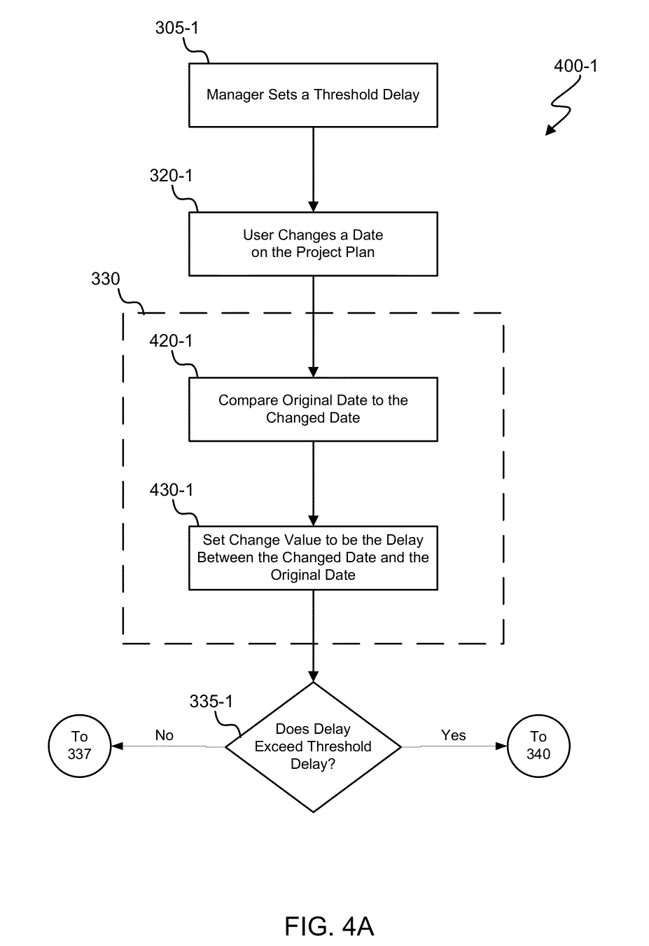

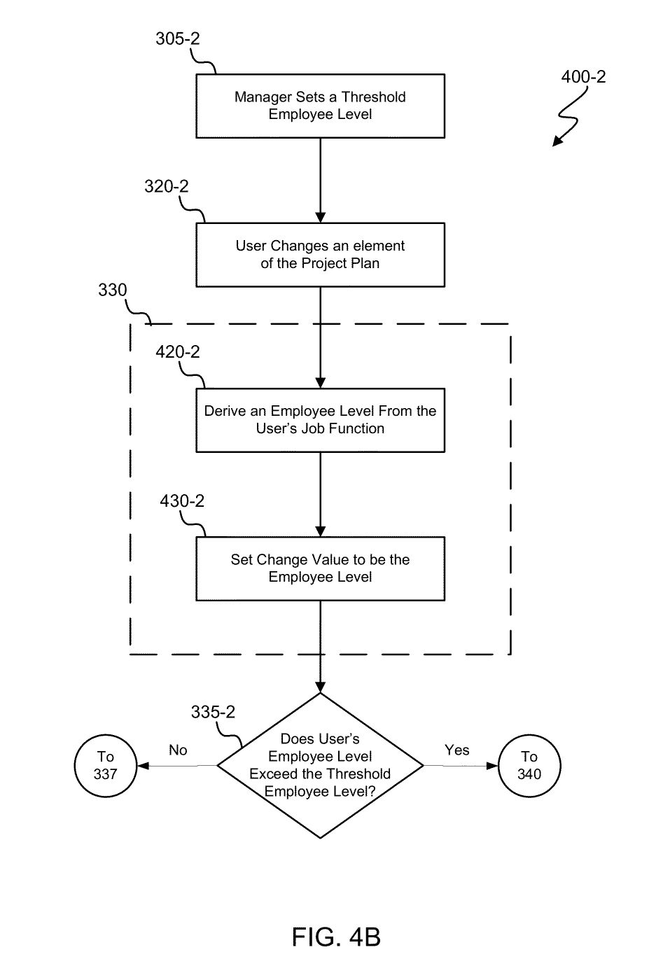

FIG. 4A illustrates a flow chart 400-1 for determining whether a particular type of change is allowed, in accordance with an embodiment of the present invention. Specifically, the flow chart 400-1 illustrates a change involving a delay threshold value. In process block 305-1, the project manager 230 sets a threshold value corresponding to a maximum delay, such as 5 days, for any task changed by any team member. While viewing the master project plan 126 in process block 320-1, the team member 220 submits a change to the schedule of the task that results in a new completion date for the task. In process block 420-1, it is determined that changes affecting the completion date of a task are related to the maximum delay threshold value, and therefore a delay value must be derived from the change. To do so, the original completion date may be compared to the changed completion date, and in process block 430-1, the change value may be set to the number of days by which the task completion will be delayed. Finally, decision block 335-1 determines whether the change value violates the threshold value by determining whether the delay caused by the change exceeds the maximum delay set by the threshold value. Depending on the determination, the changed completion date may be added to the master project plan 126, or it may generate a change exception 240 according to the process described above in FIG. 3.

FIG. 4B illustrates a flow chart 400-2 for determining whether another particular type of change is allowed, in accordance with an embodiment of the present invention. Specifically, the flow chart 400-2 illustrates a change involving the employee level of the team member 220 requesting the change. In process block 305-2, the project manager 230 sets a threshold value corresponding to a certain employee level, such as “senior technical staff,” for any task changed by any team member. While viewing the master project plan 126 in process block 320-2, the team member 220 submits a change to the schedule of the task that results in a new cost estimate for the task. In process block 420-2, it is determined that any changes by the team member 220 are related to the employee level threshold value, and therefore a change value must be derived from the change. To do so, the job title of the team member 220 may be converted into a descriptive term that is comparable to the threshold level, such as “technician,” and in process block 430-2, the change value may be set to the employee level of the team member 220. Finally, decision block 335-2 determines whether the change value violates the threshold value by determining whether the employee level of the team member 220 violates the employee level set by the threshold value. In this example, a “technician” may be considered to be less than the required “senior technical staff” level of the threshold, and the threshold might be violated. Alternatively, a “technician” may be considered to be of the same class or group as “senior technical staff” (as opposed to, say, a financial manager) and the threshold might not be violated. Depending on the determination, the changed completion cost estimate may be added to the master project plan 126, or it may generate a change exception 240 according to the process described above in FIG. 3. Of course, this situation may also include other thresholds that may need to be checked, such as cost thresholds, which may be accomplished according to the embodiments discussed herein.

If the project plan collaboration module 100 determines that no threshold violations should prevent a change from occurring, the change submitted by the team member 220 may be reflected immediately in the master project plan 126. In most cases, no copies of the project plan need to be made, and no proposed change would need to be stored in the proposed changes to the project plan 128. However, if the project plan collaboration module 100 determines that a threshold violation should prevent a change from occurring, then a change exception 240 may be generated and the proposed change may require management approval as illustrated in FIG. 3.

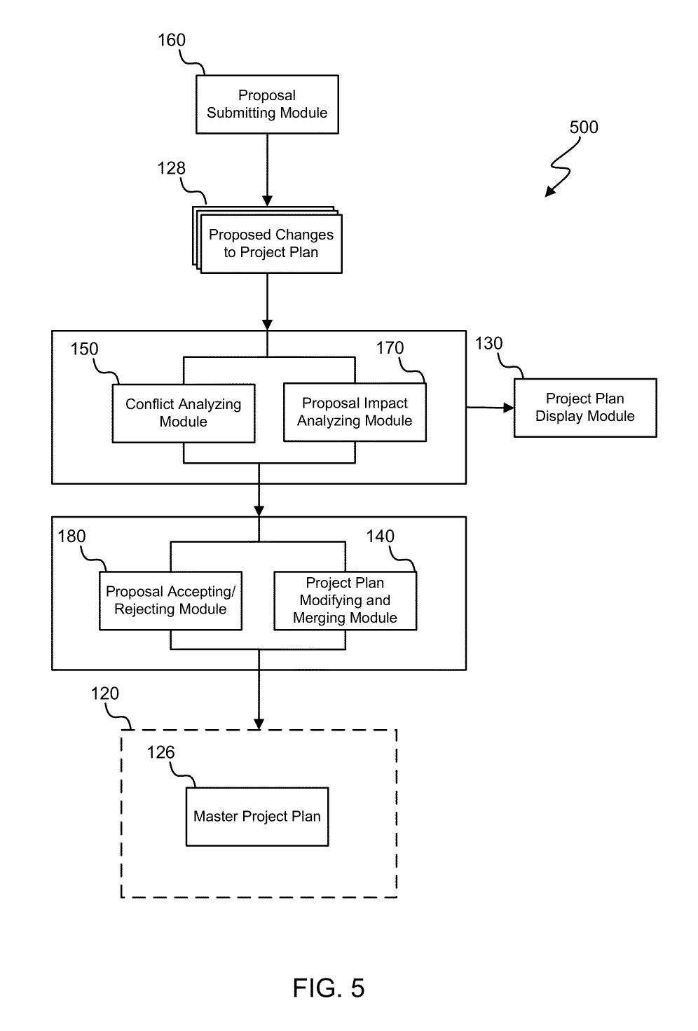

FIG. 5 illustrates a flow chart for an embodiment of one review process for changes that may violate a threshold. The proposal submitting module 160 may create a copy of the master project plan 126 that incorporates the submitted change, and then store the copy in the proposed changes to the project plan 128. Note that before this invention, any proposed change would create a copy of at least a portion of the master project plan 126, the change data, or both, often leading to hundreds of copies that the project manager 230 would need to review. These embodiments may reduce the number of copies needing review to encompass only those issues for which the project manager 230 has set the threshold values to catch.

When the manager is alerted that a proposed change requires review, the project plan collaboration module 100 may retrieve the change from the proposed changes to the project plan 128 and allow for the analysis of the change's impact on the master project plan 126. The conflict analyzing module 150 may be configured to determine whether or not the tasks and/or timeframes of master project plan 126 conflict with the proposed change. For example, there may be conflicts with respect to the assignment of tasks, timing conflicts, and/or dependency conflicts. There may also be too many tasks assigned to the team member 220 such that his/her required effort would exceed some work limit, or the single team member 220 may be assigned to conflicting projects. The proposal impact analyzing module 170 may be configured to determine any consequential changes upstream or downstream from the proposed changes. For example, if one or more tasks are changed, the impact of those changes may be carried through to other parts of the project plan. It may also analyze the impact, consequences, and/or extent of the changes on other tasks, timeframes, operators, etc., which may be associated with the master project plan 126.

The proposal impact analyzing module 170 and the conflict analyzing module 150 may operate in parallel or in series on the change data. They may also be combined into the same module or into multiple separate modules. In one embodiment, this analysis may be reported and/or visually displayed to the project manager via the project plan display module 130, where it may then be decided whether the resulting project plan is preferred to the master project plan 126.

After review, the change to the project plan may be accepted or rejected by the proposal accepting/rejecting module 180. Alternatively, the change may be modified to add additional changes or scale back some of the proposed changes in the project plan modifying and merging module 140. This same module may also allow for multiple proposed changes to be merged into a single change such that effects of multiple changes may be analyzing together. Any modifications or merging of proposals may then be sent to the proposal accepting/rejecting module 180 to be finally rejected or incorporated into to master project plan 126. Also, a project manager 230 may browse the previous project plans 124 and review the changes that were made by the team member 220 that did not require approval. If the project manager 230 disagrees with a change, even though it did not require approval, the project manager 230 may retroactively reject the change and restore a version of the master project plan 126 that does not incorporate the change.

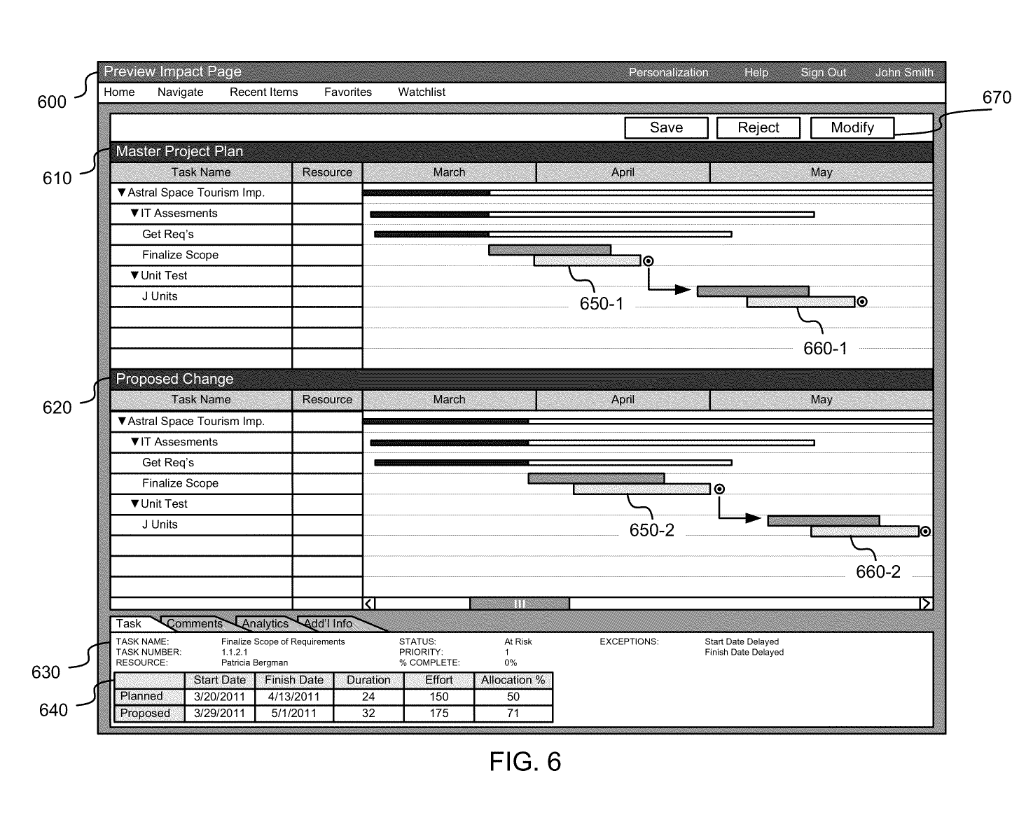

FIG. 6 illustrates a display interface 600 for analyzing proposed changes to the project plan according to one embodiment. This interface 600, entitled the “preview impact,” page may be a part of the project plan proposal module 100. The interface 600 allows the for the selection and display of various tasks for which there are proposed changes pending in the proposed changes to the project plan 126. This particular embodiment displays two Gantt charts 610, 620. The first Gantt chart 610 comprises a visual representation of the master project plan 126 before any proposed changes have been incorporated. The second Gantt chart 620 comprises a visual representation of a proposed change to the master project plan 126 where the change has been incorporated.

The interface 600 displays the effect of changing the start and end dates for a particular task 650-1 in the master project plan 126. The task 650-1 was originally scheduled to begin on Mar. 3, 2011 and end on Apr. 13, 2011. The proposed change to the task 650-1 is illustrated by the changed task 650-2. The changed task 650-2 has a modified start date of Mar. 29, 2011 and a modified end date on May 1, 2011. The interface 600 also reschedules the downstream task 660-2 that depends on the changed task 650-2. Therefore, the downstream task 660-1 in the master project plan 126 may rescheduled to a later start date as shown in the rescheduled task 660-2 to account for the delayed ending date for task 650-2. With the dates shifted, the project manager 230 can see the effect of the proposed change on the downstream task 660-2, as well as on the changed task 650-2 itself.

The interface 600 may also allow for the proposed change to be modified before it is rejected or accepted. A status window 630 may display various tabs for editing and analyzing the characteristics and effects of a proposed change. For example, the details of the change itself may be adjusted using a “task” window 640. Any alterations to the proposed changes may be displayed as they are made in the second Gantt chart 620 displaying the effects of the proposed change. Finally, action buttons 670 may be used to save the change, to reject the change, or to modify the master project plan 126 to incorporate the change. The interface 600 in FIG. 6 is merely illustrative and not meant to be limiting. In light of this disclosure, it will be understood that the many different methods and displays may be used to render changes to the project plan into a representation that makes it possible to analyze its effects and make changes. For example, other embodiments may use interfaces that use Gantt charts, spreadsheets, grids, text files, graphs, flowcharts, and/or animations to display and compare proposed changes.

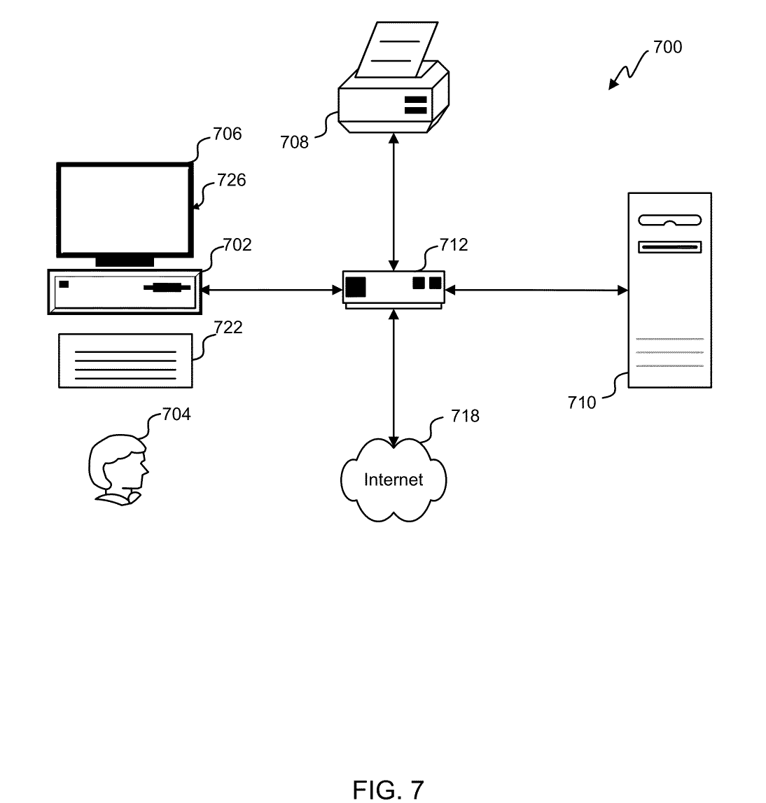

Referring next to FIG. 7, an exemplary environment with which embodiments may be implemented is shown with a computer system 700 that can be used by a designer 704 to design, for example, electronic designs. The computer system 700 can include a computer 702, keyboard 722, a network router 712, a printer 708, and a monitor 706. The monitor 706, processor 702 and keyboard 722 are part of a computer system 726, which can be a laptop computer, desktop computer, handheld computer, mainframe computer, etc. The monitor 706 can be a CRT, flat screen, etc.

A designer 704 can input commands into the computer 702 using various input devices, such as a mouse, keyboard 722, track ball, touch screen, etc. If the computer system 700 comprises a mainframe, a designer 704 can access the computer 702 using, for example, a terminal or terminal interface. Additionally, the computer system 726 may be connected to a printer 708 and a server 710 using a network router 712, which may connect to the Internet 718 or a WAN.

The server 710 may, for example, be used to store additional software programs and data. In one embodiment, software implementing the systems and methods described herein can be stored on a storage medium in the server 710. Thus, the software can be run from the storage medium in the server 710. In another embodiment, software implementing the systems and methods described herein can be stored on a storage medium in the computer 702. Thus, the software can be run from the storage medium in the computer system 726. Therefore, in this embodiment, the software can be used whether or not computer 702 is connected to network router 712. Printer 708 may be connected directly to computer 702, in which case, the computer system 726 can print whether or not it is connected to network router 712.

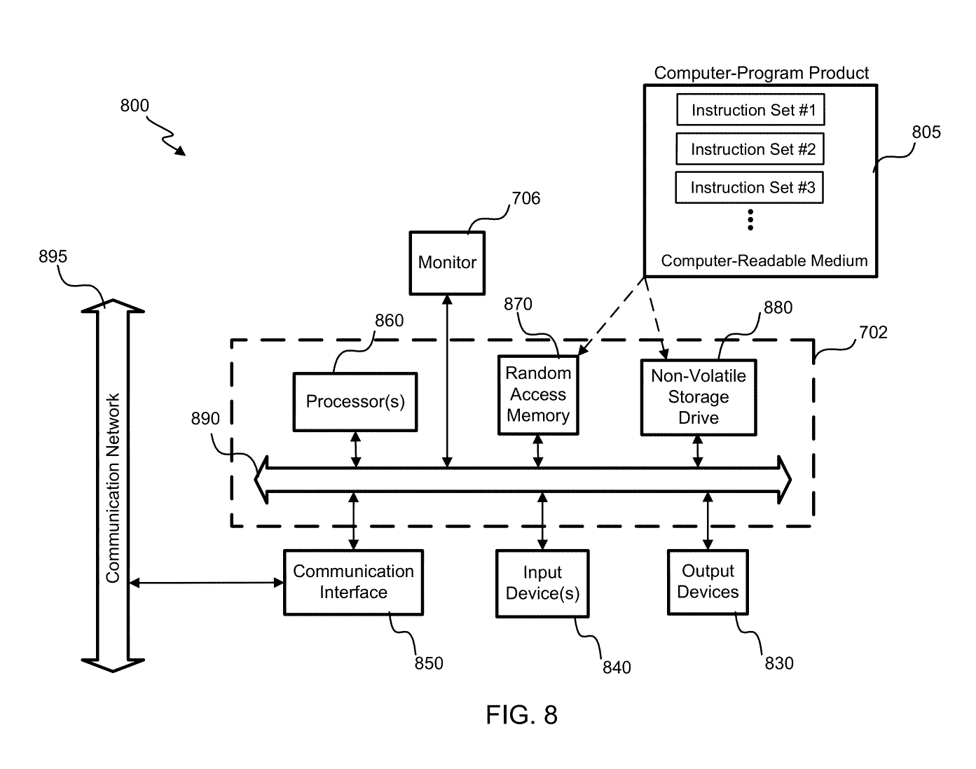

With reference to FIG. 8, an embodiment of a special-purpose computer system 800 is shown. The project collaboration module is an example of a special-purpose computer system 800. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 726, it is transformed into the special-purpose computer system 800.

Special-purpose computer system 800 comprises a computer 702, a monitor 706 coupled to computer 702, one or more additional user output devices 830 (optional) coupled to computer 702, one or more user input devices 840 (e.g., keyboard, mouse, track ball, touch screen) coupled to computer 702, an optional communications interface 850 coupled to computer 702, a computer-program product 805 stored in a tangible computer-readable memory in computer 702. Computer-program product 805 directs system 800 to perform the above-described methods. Computer 702 may include one or more processors 860 that communicate with a number of peripheral devices via a bus subsystem 890. These peripheral devices may include user output device(s) 830, user input device(s) 840, communications interface 850, and a storage subsystem, such as random access memory (RAM) 870 and non-volatile storage drive 880 (e.g., disk drive, optical drive, solid state drive), which are forms of tangible computer-readable memory.

Computer-program product 805 may be stored in non-volatile storage drive 880 or another computer-readable medium accessible to computer 702 and loaded into memory 870. Each processor 860 may comprise a microprocessor, such as a microprocessor from Intel® or Advanced Micro Devices, Inc.®, or the like. To support computer-program product 805, the computer 702 runs an operating system that handles the communications of product 805 with the above-noted components, as well as the communications between the above-noted components in support of the computer-program product 805. Exemplary operating systems include Windows® or the like from Microsoft Corporation, Solaris® from Sun Microsystems, LINUX, UNIX, and the like.

User input devices 840 include all possible types of devices and mechanisms to input information to computer system 702. These may include a keyboard, a keypad, a mouse, a scanner, a digital drawing pad, a touch screen incorporated into the display, audio input devices such as voice recognition systems, microphones, and other types of input devices. In various embodiments, user input devices 840 are typically embodied as a computer mouse, a trackball, a track pad, a joystick, wireless remote, a drawing tablet, a voice command system. User input devices 840 typically allow a user to select objects, icons, text and the like that appear on the monitor 706 via a command such as a click of a button or the like. User output devices 830 include all possible types of devices and mechanisms to output information from computer 702. These may include a display (e.g., monitor 706), printers, non-visual displays such as audio output devices, etc.

Communications interface 850 provides an interface to other communication networks and devices and may serve as an interface to receive data from and transmit data to other systems, WANs and/or the Internet 718. Embodiments of communications interface 850 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 850 may be coupled to a computer network, to a FireWire® bus, or the like. In other embodiments, communications interface 850 may be physically integrated on the motherboard of computer 702, and/or may be a software program, or the like.

RAM 870 and non-volatile storage drive 880 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 870 and non-volatile storage drive 880 may be configured to store the basic programming and data constructs that provide the functionality of various embodiments of the present invention, as described above.

Software instruction sets that provide the functionality of the present invention may be stored in RAM 870 and non-volatile storage drive 880. These instruction sets or code may be executed by the processor(s) 860. RAM 870 and non-volatile storage drive 880 may also provide a repository to store data and data structures used in accordance with the present invention. RAM 870 and non-volatile storage drive 880 may include a number of memories including a main random access memory (RAM) to store of instructions and data during program execution and a read-only memory (ROM) in which fixed instructions are stored. RAM 870 and non-volatile storage drive 880 may include a file storage subsystem providing persistent (non-volatile) storage of program and/or data files. RAM 870 and non-volatile storage drive 880 may also include removable storage systems, such as removable flash memory.

Bus subsystem 890 provides a mechanism to allow the various components and subsystems of computer 702 communicate with each other as intended. Although bus subsystem 890 is shown schematically as a single bus, alternative embodiments of the bus subsystem may utilize multiple busses or communication paths within the computer 702.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that include or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of updating a project plan in accordance with input received from a user account, the method comprising:
storing a master version of the project plan, wherein the master version of the project plan is stored as live data in a database;
receiving, from an administrative account, a threshold value, wherein the threshold value divides a range of possible values into first and second non-overlapping sets of values, and wherein the first set of values represents types of changes that may be made to the master version of the project plan in real-time without an approval from the administrative account;
after receiving the threshold value from the administrative account, receiving, from the user account, a change to the project plan; wherein
the user account has limited privileges to update the master version of the project plan in real-time; and
the administrative account has more privileges to update the master version of the project plan in real-time than the user account;
deriving a change value corresponding to the change in the project plan, wherein the change value is of the same type as the threshold value;
determining that the change value does not violate the threshold value if the change value is included in the first set of values; and
in response to determining that the change value does not violate the threshold value, updating the master version of the project plan in real-time to reflect the change in the project plan.

2. The method of updating a project plan as in claim 1, further comprising:
determining that the change value violates the threshold value if the change value is not included in the first set of values;
in response to determining that the change value violates the threshold value, generating a change exception, and providing the change exception to the administrative account for review;
after providing the change exception, accepting, from the administrative account, an authorization for the change in the project plan; and
updating the master version of the project plan to reflect the change in the project plan.

3. The method of updating a project plan as in claim 2, further comprising:
creating a changed project plan that reflects the change in the project plan;
causing to be displayed a visual representation of at least a portion of the changed project plan;
causing to be displayed a visual representation of at least a portion of the master version of the project plan together with the at least a portion of the changed project plan, wherein an effect of the change in the project plan may be visually assessed

4. The method of updating a project plan as in claim 1, wherein the threshold value comprises one or more of the following: a maximum delay, a required level of employment, or a maximum cost increase.

5. The method of updating a project plan as in claim 4, wherein:
the threshold value is a maximum delay;
the project plan includes a completion date, and the change in the project plan includes a change to the completion date;
the change value includes the time between the completion date and the change to the completion date; and
determining whether the change value violates the threshold value comprises determining whether the time between the completion date and the change to the completion date exceeds the maximum delay.

6. The method of updating a project plan as in claim 4, wherein:
the threshold value is a required level of employment;
the change value includes a level of employment associated with the user account; and
determining whether the change value violates the threshold value comprises determining whether level of employment associated with the user account meets or exceeds the required level of employment.

7. The method of updating a project plan as in claim 4, wherein:
the threshold value includes a maximum cost increase;
the project plan includes an estimated cost, and the change in the project plan includes a change to the estimated cost;
the change value includes the difference between the estimated cost and the change to the estimated cost; and
determining whether the change value violates the threshold value comprises determining whether the difference between the estimated cost and the change to the estimated cost exceeds the maximum cost increase.

8. The method of updating a project plan as in claim 1, wherein:
the change value comprises a combination of a current change value and one or more previous changes values of the same type; and
determining whether the change value violates the threshold value comprises determining whether the combination violates the threshold value.

9. The method of updating a project plan as in claim 1, wherein
the threshold value comprises a plurality of distinct threshold values;
the change value comprises a plurality of distinct change values, each corresponding to a threshold value in the plurality of threshold values to form a plurality of threshold value and change value pairs; and
determining whether the change value violates the threshold value comprises determining whether each change value violates the corresponding threshold value in the threshold value and change value pairs.

10. The method of updating a project plan as in claim 9, wherein determining whether the change value violates the threshold value further comprises combining a result from the determining whether each change value violates the corresponding threshold value using one or more Boolean operations.

11. A system for updating a project plan in accordance with input received from a user account, the system comprising:
a storage device having sets of instructions stored thereon; and
a processor coupled with the storage device, wherein the sets of instructions when executed by the processor, cause the processor to:
store a master version of the project plan as live data in a database;
receive, from an administrative account, a threshold value, wherein the threshold value divides a range of possible values into first and second non-overlapping sets of values, and wherein the first set of values represents types of changes that may be made to the master version of the project plan in real-time without an approval from the administrative account;
after receiving the threshold value from the administrative account, receive, from the user account, a change to the project plan; wherein
the user account has limited privileges to update the master version of the project plan in real-time; and
the administrative account has more privileges to update the master version of the project plan in real-time than the user account;
derive a change value corresponding to the change in the project plan, wherein the change value is of the same type as the threshold value;
determine that the change value does not violate the threshold value if the change value is included in the first set of values; and
in response to determining that the change value does not violate the threshold value, update the master version of the project plan in real-time to reflect the change in the project plan.

12. The system for updating a project plan as in claim 11, wherein the sets of instructions further cause the computer to:
determine that the change value violates the threshold value if the change value is not included in the first set of values;
generate a change exception, and provide the change exception to the administrative account for review in response to determining that the change value violates the threshold value.
accept, from a administrative account, an authorization for the change in the project plan in response to providing the change exception; and
update the master version of the project plan to reflect the change in the project plan.

13. The system for updating a project plan as in claim 11, wherein the sets of instructions further cause the computer to:
create a changed project plan that reflects the change in the project plan;
cause to be displayed a visual representation of at least a portion of the changed project plan;
cause to be displayed a visual representation of at least a portion of the master version of the project plan together with the at least a portion of the changed project plan, wherein an effect of the change in the project plan may be visually assessed.

14. The system for updating a project plan as in claim 11, wherein:
the threshold value comprises a plurality of distinct threshold values;
the change value comprises a plurality of distinct change values, each corresponding to a threshold value in the plurality of threshold values to form a plurality of threshold value and change value pairs; and
determining whether the change value violates the threshold value comprises determining whether each change value violates the corresponding threshold value in the threshold value and change value pairs.

15. The system for updating a project plan as in claim 11, wherein:
the change value comprises a combination of a current change value and one or more previous changes values of the same type; and
determining whether the change value violates the threshold value comprises determining whether the combination violates the threshold value.

16. The system for updating a project plan as in claim 11, wherein:
updating the master version of the project plan to reflect the change in the project plan occurs without an approval from the administrative account.

17. A computer-readable medium having sets of instructions stored thereon which, when executed by a computer, cause the computer to:
store a master version of the project plan as live data in a database;
receive, from an administrative account, a threshold value, wherein the threshold value divides a range of possible values into first and second non-overlapping sets of values, and wherein the first set of values represents types of changes that may be made to the master version of the project plan in real-time without an approval from the administrative account;
after receiving the threshold value from the administrative account, receive, from the user account, a change to the project plan; wherein
the user account has limited privileges to update the master version of the project plan in real-time; and
the administrative account has more privileges to update the master version of the project plan in real-time than the user account;
derive a change value corresponding to the change in the project plan, wherein the change value is of the same type as the threshold value;
determine that the change value does not violate the threshold value if the change value is included in the first set of values; and
in response to determining that the change value does not violate the threshold value, update the master version of the project plan in real-time to reflect the change in the project plan.
generate a change exception, and provide the change exception for review by the administrative account in response to determining that the change value does not violate the threshold value.

18. The computer-readable medium as in claim 17, wherein the instructions further cause the computer to:
cause to be displayed to the user account a graphical representation of the master project plan, wherein the graphical representation comprises a Gantt chart.

19. The computer-readable medium as in claim 17, wherein the instructions further cause the computer to:
create a changed project plan that reflects the change in the project plan;
cause to be displayed a visual representation of at least a portion of the changed project plan;
cause to be displayed a visual representation of at least a portion of the master version of the project plan together with the at least a portion of the changed project plan, wherein an effect of the change in the project plan can be visually assessed.

20. The computer-readable medium as in claim 19, wherein:
the change to the project plan directly affects a first task; and
the display of the at least a portion of the changed project plan comprises displaying a resulting change to a second task that depends on the first task.
